(19) United States
(12) Patent Application Publication
(10) Pub. No.: US 2010/0093236 A1
(43) Pub. Date: Apr. 15, 2010

(54) Recreational pet float / play platform

(76) Inventors: Joanne Daley Harris, Micco, FL (US); Klaus Juergen Harris, Micco, FL (US)

Correspondence Address: Joanne Daley Harris;Klaus Juergen Harris, 3965 Baldwin Dr, Micco, FL, 32976, US

(21) Appl. No.: 12/587,145

(22) Filed: Oct. 2, 2009

Related U.S. Application Data
(60) Provisional application No. 61/195,189, filed on Oct. 3, 2008.

(51) Int. Cl. A01K 29/00; B63B 35/73

(52) U.S. Cl. 441/129; 119/702

(57) ABSTRACT

A non-inflatable flotation device for pets to enjoy water play activities. The buoyant semi-rigid frame consists of PVC or similar material encased in a cylindrical buoyant tube made from closed cell polyethylene or similar material. The frame is wrapped in a woven mesh fabric of vinyl, polyester or similar material that is waterproof, ultraviolet resistant, and resistant to the effects of claws, teeth and rough play. The fabric has sleeves sewn in to allow easy insertion of the frame. The device is sized to accommodate pets of different weights. The semi flexible frame allows for the trampoline to form a sling type configuration under the weight of a pet, to provide a secure and stable semi submerged floating environment. The semi flexible and semi submersible nature of the device allows for the pet to mount and dismount the device without pet owners' assistance.

### CROSS-REFERENCE TO RELATED APPLICATIONS

This application claims priority of U.S. provisional application No. 61/195,189 which was filed on Oct. 3, 2008.

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING

Not Applicable

### BACKGROUND OF THE INVENTION

1. Field of Invention

This invention relates generally to recreational flotation devices and more particularly to a non-inflatable, semi-submersible device for pets to play on.

Many pet owners have pets that enjoy swimming and playing in the water. People enjoy lounging in the water on recreational flotation devices, and their pets often try to imitate them by getting on such devices; but they are not made to support a pet, or to withstand rough play.

2. Description of Related Art

Existing flotation devices in both the inflatable and non-inflatable categories such as, chairs, rafts, slings, hammocks and boogie boards are not suitable for various reasons including, risk of puncture by claws or teeth, instability, and difficulty of access (mounting and dismounting of flotation device).

It would be an improvement on the current art to create a flotation device designed specifically to meet a swimming pets' needs. The device would need a semi-rigid frame to support a pet that is simply standing, sitting, or jumping onto the device from a higher level such as a pool deck. It would also require a mesh surface so that it would partially submerge to allow ease of mounting and dismounting from the water, thus enabling the pet to rest periodically during play without having to exit the water.

### BRIEF SUMMARY OF THE INVENTION

The invention is a flotation device for pets. The semi-rigid frame consists of PVC or similar material encased in a cylindrical buoyant tube made from closed cell polyethylene or similar material. The frame is wrapped in a woven mesh fabric of vinyl, polyester or similar material that is waterproof and UV resistant. The fabric has sleeves sewn in to allow easy insertion of the frame. The device is sized to accommodate pets of different weights.

An object of the present invention is to provide a simple and inexpensive flotation device for buoyancy of a pet while playing in the water.

Another object of the present invention is to provide flotation support that has stability in the water and will not lose its buoyancy because it can not be punctured.

Another object of the present invention is to provide a durable, stable device that can withstand the vigorous play of an animal that includes, biting, clawing, or jumping on to the device from a higher level such as a pool deck.

Another object of the present invention is to allow the pets to float while being partially submerged in the water.

Another object of the present invention is to provide a device that is easy to get onto and off of from the water.

Another object of the present invention is to have excellent stability to allow the pet to rest periodically during play without having to exit the water.

Another object of the present invention is to provide a device which is lightweight yet sturdy.

Another object of the present invention is to provide a device that is durable and long lasting.

Another object of the present invention is to allow mass production with readily available material.

### BRIEF DESCRIPTION OF SEVERAL VIEWS OF THE DRAWING

FIG. 1 is a perspective view of the flotation device in use by a standing pet.

FIG. 2 is an assembled plan view of the frame portion of the flotation device.

FIG. 3 is a plan view of the mesh fabric that forms the body of the flotation device.

FIG. 4 is a plan view of the mesh fabric folded at the corners.

FIG. 5 is a plan view of the bottom of the assembled flotation device.

FIG. 6 is a plan view of the top of the assembled flotation device with an exposed view of one corner.

### DETAILED DESCRIPTION OF THE INVENTION

Many people have pets that love to swim and play in the water. It was recognized by the inventor that a device could be constructed using readily available materials to accommodate the needs of a pet during water play. The pet flotation device is resistant to the effects of claws, teeth and rough play. In addition to potential pet damage, it can withstand the element of outdoors, such as pool chemicals, salt water and ultraviolet rays. The device has a semi-rigid buoyant frame to support a pet that is standing, sitting, or jumping onto the device. Its surface area is constructed of mesh so that the pet will be partially submerged to allow ease of mounting and dismounting from the water, thus enabling the pet to rest periodically during play without having to exit the water. At no time does the pet need assistance to enjoy the benefits of the device.

The device consists of sling body constructed of water resistant mesh material. The material is preferably a woven mesh fabric of vinyl, polyester or similar material that is waterproof and ultraviolet resistant. The semi-rigid support frame is constructed of PVC (polyvinyl chloride), CPVC (chlorinated polyvinyl chloride), or polypropylene pipe, which is inserted into cylindrical foam tubes. The foam tube, popularly know as a NOODLE, is made of a closed cell foam, which provides buoyancy and durability.

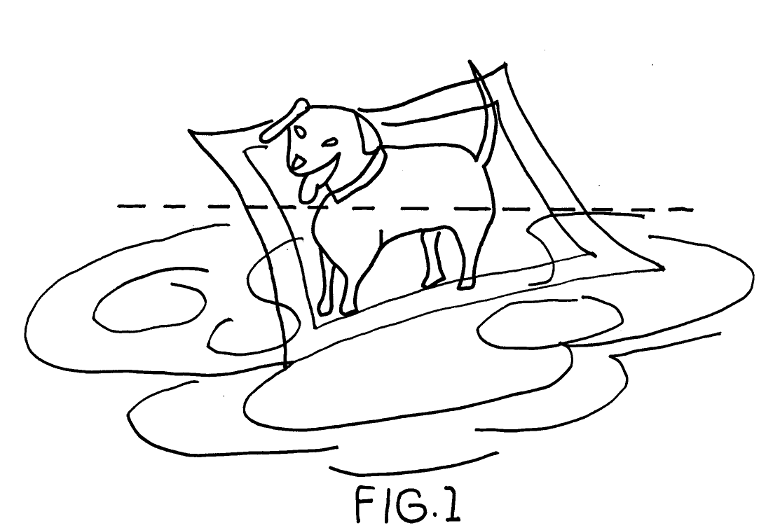

FIG. 1 is a perspective view of the flotation device in use by a pet standing up. Approximately one half of the device is submerged in the water. Partial submersion keeps the float from pushing away or popping out from under the pet when weight is applied to it.

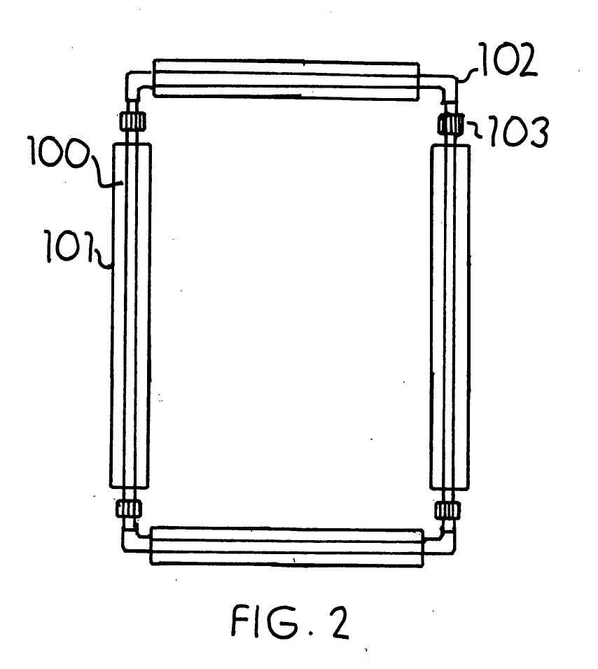

FIG. 2 is an assembled plan view of the frame portion of the flotation device. This figure is for illustration purposes only; the frame should be inserted into the mesh body of the raft, prior to full assembly. The frame consists of lengths of pvc pipe 100, inserted into cylindrical foam tubes which have a hole in the center 101. One 90 degree pvc street elbow 102, and one threaded pvc union 103 are fitted at each corner of frame.

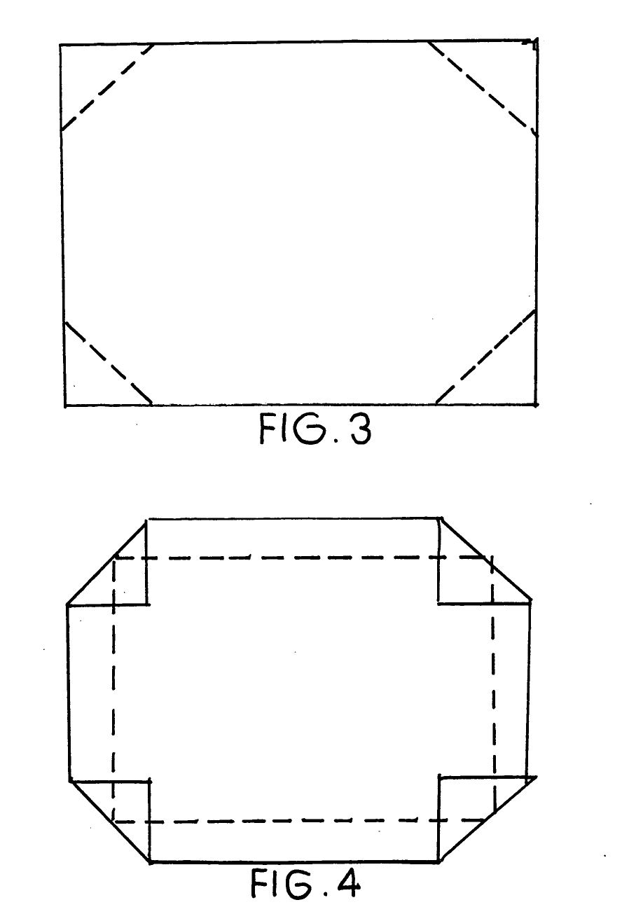

FIG. 3 is a plan view of the mesh fabric that forms the body of the flotation device. Dashed lines indicate where fabric is to be folded; the outer edges of each folded corner will be stitched.

FIG. 4 is a plan view of the mesh fabric which has been folded at the corners, and stitched. Dashed lines indicate where fabric is to be folded; the outer edges of each fold will be stitched.

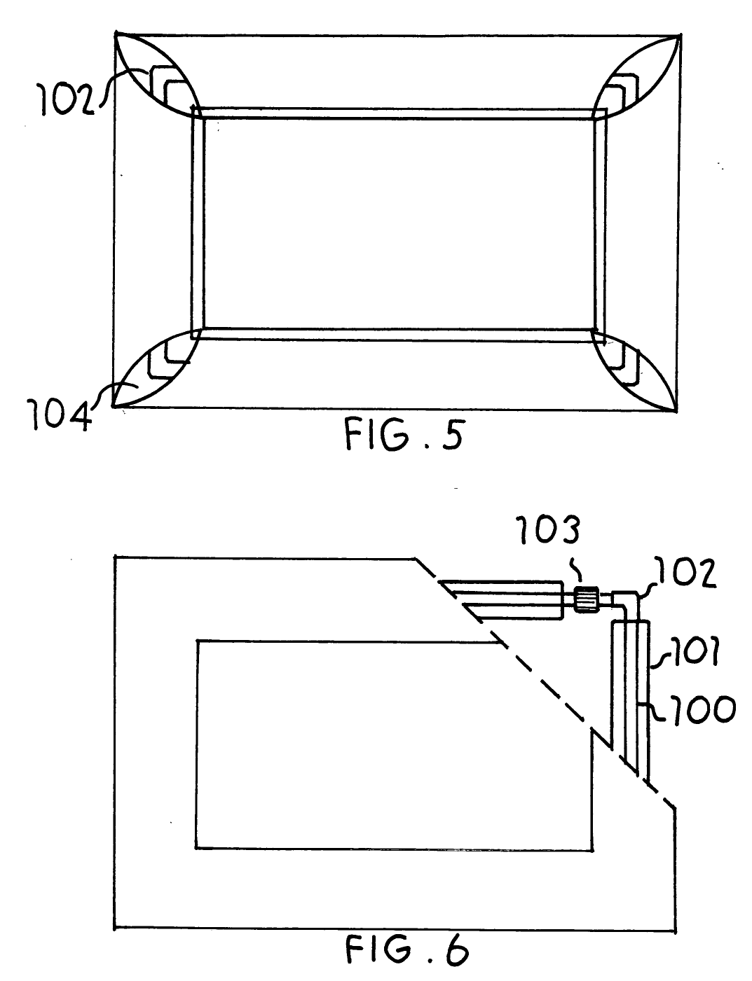

FIG. 5 is a plan view of the bottom of the assembled flotation device; the elbows 102 are visible at each corner pocket 104.

FIG. 6 is a plan view of the top of the assembled flotation device with an exposed view of one corner, exposing the inserted, assembled frame.

The fully assembled device as shown in FIGS. 1, 5 and 6 is assembled using the mesh fabric shown in FIGS. 3 and 4. FIG. 3 is folded at each corner, and stitched, resulting in FIG. 4; which is folded again and stitched to produce pockets. FIG. 5 reveals the pockets 104 in which the frame parts of FIG. 2 can be inserted. The frame assembly in FIG. 2 begins by inserting the pvc pipes, 100 into the noodles 101; which are inserted into the pockets 104 of the mesh fabric. Each corner is connected using one 90 degree pvc street elbow 102, and one threaded pvc union 103.

It will be appreciated that the above description relates to the preferred embodiment by way of example only. Many variations on the invention will be obvious to those knowledgeable in the field, and such obvious variations are within the true spirit of the scope of the invention as described and claimed, whether or not expressly described.

What is claimed is:

1. A non-inflatable, semi submersible pet flotation device configured to support a pet for water play, and allow easy access from the water, said flotation device comprising a trampoline or sling consisting of mesh fabric with sleeves sewn in around the perimeter to accommodate a semi-rigid, collapsible buoyant frame inserted in said sleeves.

2. A pet flotation device in accordance with claim 1 wherein said trampoline or sling is formed from woven mesh waterproof fabric.

3. A pet flotation device in accordance with claim 1 wherein said semi rigid buoyant frame is pvc, cpvc, or polypropylene pipe, inserted into cylindrical tubes made of a closed cell foam.

4. A pet flotation device in accordance with claim 1 wherein said semi rigid buoyant frame is pvc, cpvc, or polypropylene pipe filled with foam formed from polyurethane resin or polystyrene beads.
